(19) United States
(12) Patent Application Publication
(10) Pub. No.: US 2004/0266597 A1
(43) Pub. Date: Dec. 30, 2004

(54) Rear service packaging apparatus

(76) Inventor: Richard Archer Melville, Auckland (NZ)

Correspondence Address: Patrick D Richards, McDermott Will & Emery, 227 West Monroe Street, Chicago, IL, 60606-5096, US

(21) Appl. No.: 10/486,533

(22) PCT Filed: Aug. 15, 2002
(86) PCT No.: PCT/NZ02/00158

(30) Foreign Application Priority Data
Aug. 15, 2001 (NZ) 513589

(51) Int. Cl. B31B 1/62

(52) U.S. Cl. 493/149

(57) ABSTRACT

The present invention discloses a packaging apparatus (10) for producing packages of variable lengths from rolls of plastic film wherein the apparatus produces packages to be accessed at a first, or front, end (22) of the apparatus (10) and the apparatus may be serviced from a second, or rear, end (24) of the apparatus. The apparatus (10) comprises a frame (12) wherein a plurality of packaging devices, two being shown, (14, 16) are slidably mounted on a sliding roller mounting mechanism (18, 20). Each packaging device (14, 16) can be pulled backwards from the frame (12) along a sliding roller mounting mechanism (18, 20) such that each packaging device (14, 16) may be serviced at the rear of the frame (12) without interfering with the operation of the other packaging devices.

### FIELD OF THE INVENTION

The present invention relates to an apparatus for producing packages. More specifically, the present invention relates to an apparatus for producing packages of variable lengths from rolls of plastic film wherein the packages produced are accessible at a first end of the device and the apparatus is accessible for service at a second end of the device.

### BACKGROUND OF THE INVENTION

Packaging devices for producing packages of variable lengths from rolls of plastic film are known in the art. One such device is disclosed in U.S. Pat. No. 5,618,252 and is incorporated herein by reference in its entirety. Commonly, one or more packaging devices are mounted to a frame that is located adjacent to an infeed conveyor at a packaging workstation. Each device is loaded with a roll of plastic film for forming packages. Each device can make packages of varying length from a single stock of plastic film; however, the width of the package is controlled by the width of the plastic film loaded into each device. More than one device is used so that different widths can be created at a single workstation. For example, one device can be loaded with a tube of plastic film that is six inches wide and a second device can be loaded with a tube of plastic film that is eight inches wide. As a result, a package can be created with either a six-inch width or an eight-inch width, depending on the product to be packaged. The infeed conveyor typically carries product to be bagged to an operator located at the front of the frame and packaging devices. As each product to be bagged arrives at the packaging workstation, the operator accesses a package that has been produced at the front of one of the packaging devices, removes the package from the device, places the product in the package, and transfers the bagged product to an outfeed conveyor.

In addition to a motorized drive roller system for feeding plastic film through the packaging device, packaging devices may also include one or more of any of the following components; a heat sealing device, a blower head, a suction device, a proximity sensor, a printing device, or any similar component. Invariably, one or more of these components will require servicing, whether routine or emergency, during the operation of the packaging apparatus. For example, the printer ribbons of printing devices require frequent replacement.

In the past, when any one of the packaging devices at a packaging workstation required servicing, the operation of, or access to, the remaining packaging devices was disrupted. For example, when a servicing operator accessed an individual packaging device component requiring service, the workstation operator's access to the packages produced by the remaining operational bagging devices was interfered with. The disruption resulted from either the position of the servicing operator, the position of the packaging device requiring service, the position of the operational packaging devices, or any combination thereof.

Accordingly, it would be beneficial to provide an apparatus for producing packages of variable lengths from rolls of plastic film wherein the packaging devices may be accessed for service without disrupting the operation of, or access to, the remaining packaging devices of the packaging apparatus.

It has been found that providing a packaging apparatus for producing bags of variable length from rolls of plastic film including one or more packaging devices wherein the packages produced are accessible at a first end of the apparatus and the devices of the apparatus are accessible for service at a second end of the apparatus allows one or more of the packaging devices at a packaging workstation to be accessed for service without disrupting the operation of, or access to, the remaining packaging devices at the packaging workstation.

### OBJECTS OF THE INVENTION

It is therefore one of the principal objectives of a preferred embodiment of the present invention to provide a packaging apparatus for producing bags of variable length from rolls of plastic film wherein the packages produced are accessible at a first end of the apparatus and the apparatus is accessible for service at a second end of the apparatus.

It is another objective of an embodiment of the present invention to provide a packaging device for use in a packaging apparatus that produces packages for access by an operator at a first end.

It is a further objective of an embodiment of the present invention to provide a packaging device for use in a packaging apparatus that may be accessed for service by an operator at a second end.

It is yet another objective of an embodiment of the present invention to provide a packaging device for mounting to a frame containing a plurality of packaging devices such that any one of the packaging devices may be accessed from the rear of the frame without interfering with the operation of the other packaging devices at that front of the frame.

It is still another objective of an embodiment of the present invention to provide a packaging apparatus wherein any of a plurality of packaging devices may be removed from the packaging apparatus without affecting the operation of any packaging devices remaining in the packaging apparatus.

It is an additional or alternative objective of the present invention to overcome or at least aneliorate the aforementioned problems of packaging devices available to the present time or to at least provide the public with a useful choice.

### SUMMARY OF THE INVENTION

According to one aspect of the present invention an apparatus for producing packages of variable lengths from rolls of plastic film includes:

a frame having a front and a rear;

a sliding roller mechanism mounted to said frame; and

a packaging device for producing packages at said front of said frame, wherein said packaging device is mounted to said sliding roller mechanism such that said packaging device can be accessed for service at said rear of said frame.

According to a further aspect of the present invention a method of mounting a packaging device for producing packages of variable lengths from rolls of plastic film to a frame having a front and a rear includes the steps of:

providing a sliding roller mechanism;

mounting said sliding roller mechanism to the frame; and

mounting the packaging device to the sliding roller mechanism such that the packaging device can produce packages at the front of the frame and can be accessed for service at the rear of the frame.

According to a still further aspect of the present invention a method of operating a bagging workstation having an infeed conveyor carrying product to be bagged and a packaging apparatus, wherein the packaging apparatus includes a plurality of bagging devices and the packaging apparatus has a front and a rear, wherein one or more of the bagging devices requires service includes the steps of:

bagging the product carried by the infeed conveyor at the front of the packaging apparatus; and

concurrently accessing the one or more bagging devices that require service from the rear of the packaging apparatus.

Further aspects of this invention which should be considered in all its novel aspects will become apparent from the following description given by way of example of possible embodiments of the invention and with reference to the accompanying drawings.

### BRIEF DESCRIPTION OF THE DRAWINGS

FIG. 1: is a perspective view of a packaging apparatus of one embodiment of the present invention including two packaging devices mounted to a frame by sliding roller mechanisms, wherein one packaging device is in position for operation and a second packaging device is in position for servicing.

FIG. 2a: is cross-sectional right side view of one side of a sliding roller mechanism of one embodiment of the present invention with a packaging device located in the first position.

FIG. 2b: is a cross-sectional right side view of one side of a sliding roller mechanism of one embodiment of the present invention with a packaging device translating towards the second position from the first position.

FIG. 2c: is a cross-sectional right side view of one side of a sliding roller mechanism of one embodiment of the present invention with a packaging device located in the second position.

FIG. 2d: is a cross-sectional right side view of one side of a sliding roller mechanism of one embodiment of the present invention with a packaging device translating towards the first position from the second position.

FIG. 3: is a rear view of a packaging apparatus of one embodiment of the present invention.

### DETAILED DESCRIPTION OF THE DRAWINGS

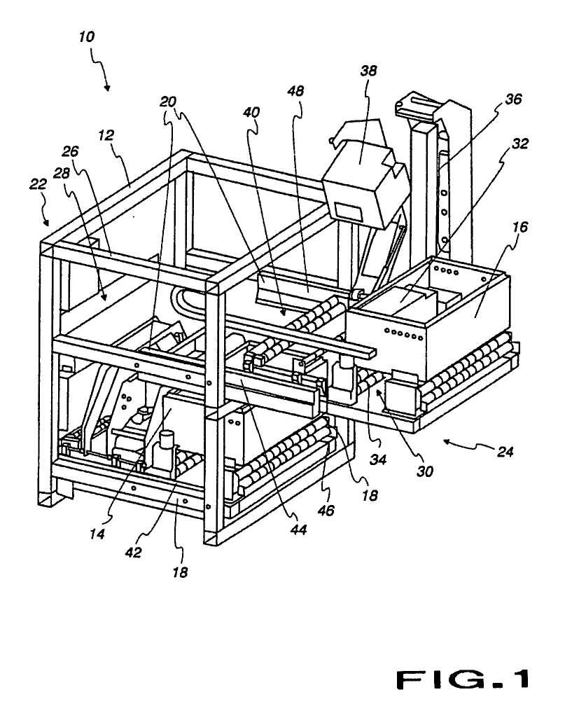

Referring now to FIG. 1, one embodiment of the packaging apparatus 10 of the present invention is shown. As shown in FIG. 1, the packaging apparatus 10 has a frame 12 with a first packaging device 14 and a second packaging device 16 mounted thereto. The first device 14 is mounted on a first sliding roller mechanism 18 and the second device 16 is mounted on a second sliding roller mechanism 20. The first packaging device 14 and the second packaging device 16 are collectively referred to herein as the packaging devices 14,16. Similarly, the first sliding roller mechanism 18 and the second sliding roller mechanism 20 are collectively referred to herein as the sliding roller mechanisms 18,20. In addition to the embodiment shown in FIG. 1, the packaging apparatus 10 of the present invention may include any number of packaging devices 14,16 mounted to one or more frames 12 on an equal number of sliding roller mechanisms 18,20. For example, eight packaging devices 14,16 may be mounted to one frame 12 on eight sliding roller mechanisms 18,20 such that the packaging devices 14,16 are mounted to the frame 12 in two rows and four columns. Alternatively, the packaging apparatus 10 of the present invention may be configured in any manner apparent to one skilled in the art.

The packaging devices 14,16 produce packages at the front 22 of the packaging apparatus 10. The back 24 of the packaging apparatus 10 is the side of the packaging apparatus 10 opposite the front 22.

As shown in FIG. 1, the frame 12 comprises a plurality of beams 26 interconnected to provide structural support for the packaging apparatus 10. In the embodiment of the packaging apparatus 10 illustrated in FIG. 1, the frame 12 is a monocoque constructed using stainless steel beams 26. Alternatively, the frame 12 and beams 26 may be constructed of any material capable of supporting the sliding roller mechanisms 18,20, and the packaging devices 14,16 mounted thereto, as would be apparent to one skilled in the art. For example, possible alternative materials for the frame 12 may include aluminum or rigid plastic.

The frame 12 may form a plurality of compartments 28 wherein the packaging devices 14,16 may be located. In the packaging apparatus 10 shown in FIG. 1, the frame 12 includes at least one compartment 28 for each of the packaging devices 14,16. Each compartment 28 may include at least two beams 26 for mounting the sliding roller mechanisms 18,20 thereto, as will be further described below. Alternatively, there may be any number of compartments 28 configured in any manner apparent to one skilled in the art.

Each of the packaging devices 14,16 of the present invention produce packages of varying lengths from rolls of plastic film that may be accessed by a packaging operator (not shown) at the first end 22 of the packaging apparatus 10. The packaging devices 14,16 may be the packaging apparatus disclosed in U.S. Pat. No. 5,618,252 which is incorporated herein by reference in its entirety. The packaging devices 14,16 shown in FIG. 1 receive tubular plastic film that is fed to the packaging devices 14,16 from a location adjacent to the packaging apparatus 10. The plastic film is fed through a drive means 30, including a motor 32, a plurality of drive rollers 34, and an electronic control means (not shown) for providing a proper length of film to produce a package of the desired size. The drive means 30 passes a predetermined length of plastic film to a sealing and cutting means 36 which seals and cuts a predetermined length of plastic film to form a properly sized package. Once the package is formed, a printing device 38 can be used to print identification on the package. For example, the printing device 38 may be used to mark a package with the date of packaging. Once the package has been formed and printed, the drive means 30 may position the package at a first end 40 of the packaging device 14,16. Alternatively, the packaging devices 14,16 may be any other packaging device capable of producing packages of varying lengths from rolls of plastic film as would be known to one skilled in the art.

Each of the packaging devices 14,16 mounts to one of the sliding roller mechanisms 18,20 such that each of the packaging devices 14,16 may be located at a first position within one of the compartments 28 of the frame 12 or at a second position outside of the frame 12 at the back 24 of the packaging apparatus 10. When located in the first position, the first end 40 of each of the packaging devices 14,16 is located adjacent to the front 22 of the packaging apparatus 10 such that the packaging devices 14,16 may produce packages that can be accessed by the packaging operator located at the front 22 of the packaging apparatus 10. When located in the second position, each of the packaging devices 14,16 may be serviced by a servicing operator (not shown) without impairing the operation of, or the packaging operator's access to, any of the packaging devices 14,16 located in the first position.

In FIG. 1, the first packaging device 14 is shown in the first position within one of the compartments 28 of the frame 12 and the second packaging device 16 is shown in the second position outside of the frame 12 at the back 24 of the packaging apparatus 10. The first and second positions may or may not be located at the extreme positions of translation of the packaging devices 14,16 and roller mechanisms 18,20. For example, the packaging apparatus 10 may be configured such that the packaging devices 14,16 may be located at a first position within one of the compartments 28 of the frame 12, at a second position outside of the frame 12 at the back 24 of the packaging apparatus 10, or at a third position outside of the frame 12 at another side of the packaging apparatus. Further, the packaging devices 14,16 and sliding roller mechanisms 18,20 may be configured such that the packaging devices 18,20 may be located at any position in between the first and second positions. Moreover, the frame 12, the packaging devices 14,16 and the sliding roller mechanisms 18,20 may be configured such that the packaging devices may be located in any other position apparent to one skilled in the art.

As shown in FIG. 1, when located in the second position, the various parts of the second packaging device 16 that may require servicing, such as the drive means 30, the sealing and cutting means 36, and the printing device 38, are accessible to the servicing operator from the back 24 of the packaging apparatus 10. Consequently, the second packaging device 16 may be serviced by the servicing operator without interrupting the operation of the first packaging device 14 or the packaging operator located at the front 22 of the packaging apparatus 10.

Further, each of the packaging devices 14,16 may be completely removed from the frame 12 without interrupting the operation of any packaging device 14,16 remaining in the packaging apparatus 10. The packaging devices 14,16 may be operated independently of the packaging apparatus 10, or loaded into another apparatus as would be apparent to one skilled in the art.

Each of the sliding roller mechanisms 18,20 shown in FIG. 1 includes a first side 42,44 and a second side 46,48 respectively. The first sides 42,44 and second sides 46,48 are collectively referred to herein as sliding roller mechanism sides 42,44,46,48. Each of the sliding roller mechanism sides 42,44,46,48 operates in substantially the same manner as the first side 42 of the first sliding roller mechanism 18 as described below. Alternatively, the sliding roller mechanisms 18,20 may be configured such that the packaging devices 14,16 may be moved between the first and second positions in any manner apparent to one skilled in the art.

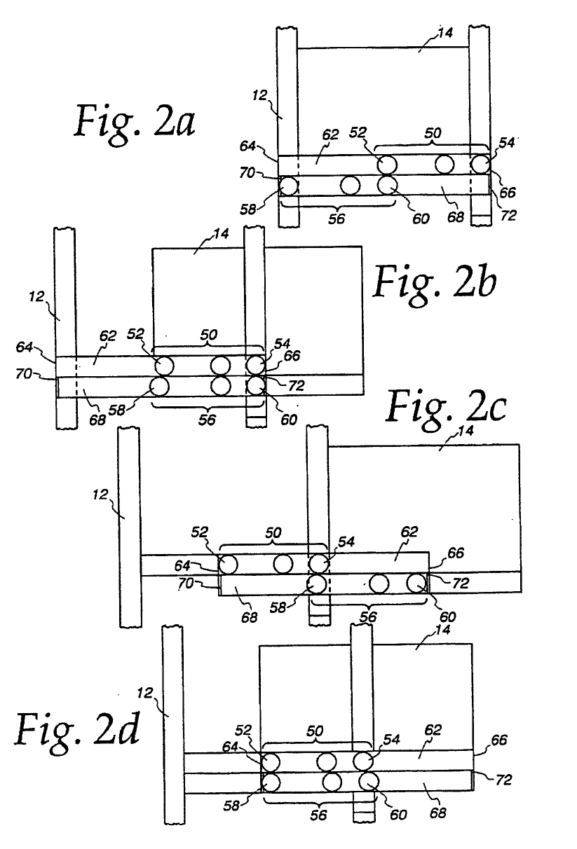

An embodiment of the first side 42 of the first sliding roller mechanism 18 with the first packaging device 14 located in the first position is shown in FIG. 2a. As shown in FIG. 2a, the first side 42 of the first sliding roller mechanism 18 may include: a first plurality of rollers 50, including a first roller 52 and a second roller 54; a second plurality of rollers 56, including a third roller 58 and a fourth roller 60; a first roller track 62 having a first stop 64 and a second stop 66; and a second roller track 68 having a third stop 70 and a fourth stop 72. The first plurality of rollers 50 and the second plurality of rollers 56 are collectively referred to herein as the rollers 50,56. The first roller track 62 and the second roller track 68 are collectively referred to herein as the roller tracks 62,68. The first plurality of rollers 50 may be rotatably mounted to one of the beams 26 of the frame 12. The second plurality of rollers 56 may be rotatably mounted to the first packaging device 14. The first roller track 62 may be configured to slidably couple with the first plurality of rollers 50. The second roller track 68 may be configured to slidably couple with the second plurality of rollers 56. Further, the roller tracks 62,68 may be secured to each other such that they remain in a fixed position with respect to each other.

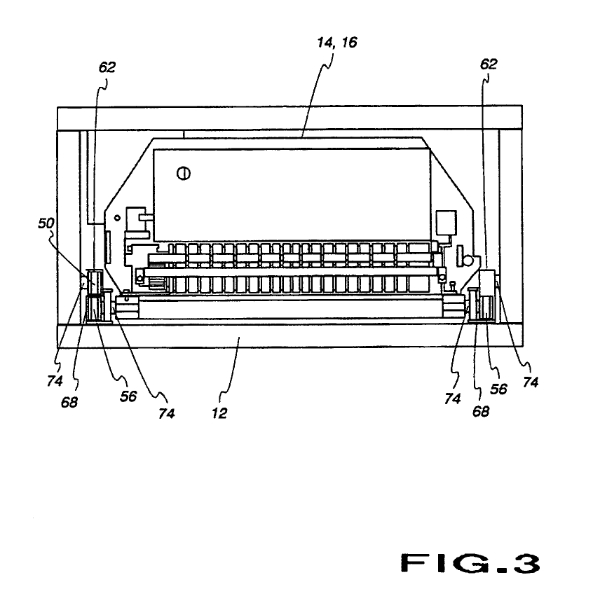

FIG. 3 illustrates one example of how the rollers 50,56 couple to the roller tracks 62,68. As shown in FIG. 3, each roller 50,56 is rotatably coupled to an axle 74 that is affixed to either the frame 12 or the packaging device 14,16. For example, as shown in FIG. 3, the first plurality of rollers 50 attach to the frame 12 and the second plurality of rollers 56 attach to the first packaging device 14. The rollers 50,56.are held within the roller tracks 62,68 and may translate along the roller tracks 62,68 towards the front 22 and back 24 of the packaging apparatus 10. In another contemplated embodiment of the packaging apparatus (not shown), the roller tracks 62,68 may be designed to allow the rollers 50,56 to translate towards the other sides of the packaging apparatus. Alternatively, the roller tracks 62,68 may be designed to allow the first packaging device 14 to translate into and out of the frame 12 in any manner apparent to one skilled in the art.

FIGS. 2a-2d illustrate, in sequence, how the first packaging device 14 may be moved from the first position to the second position and back to the first position again along the first side 42 of the first sliding roller mechanism 18. FIG. 2a illustrates the first packaging device 14 in the first position. FIG. 2c illustrates the first packaging device 14 in the second position.

As shown in FIG. 2a, the second roller 54 is located adjacent to the second stop 66 and the third roller 58 is located adjacent to the third stop 70. As the first packaging device 14 moves towards the second position, the second plurality of rollers 56 translate along the second roller track 68 until the fourth roller 60 contacts the fourth stop 72, as shown in FIG. 2b. Once the packaging apparatus 10 is in the position shown in FIG. 2b, the second plurality of rollers 56 can no longer translate along the second roller track 68 due to the position of the fourth stop 72. From the position shown in FIG. 2b, the roller tracks 62,68 translate towards the rear 24 of the packaging apparatus 10. As the roller tracks 62,68 move towards the rear 24 of the packaging apparatus 10, the first plurality of rollers 50 remain in a fixed position with respect to the frame 12. The roller tracks 62,68 continue to move towards the rear 24 of the packaging apparatus 10 until the first roller 52 contacts the first stop 64 placing the first packaging device 14 in the second position, as shown in FIG. 2c.

From the second position, the first packaging device 14 may be moved back into the first position. From the second position, the first packaging device 14 may be moved towards the front 22 of the packaging apparatus 10. As the first packaging device 14 moves towards the front 22, the second plurality of rollers 56 translate along the second roller track until the third roller 58 contacts the third stop 70, as shown in FIG. 2d. Once the packaging apparatus 10 is in the position shown in FIG. 2d, the second plurality of rollers 56 can no longer translate along the second roller track 68 due to the position of the third stop 70. From the position shown in FIG. 2d, the roller tracks 62,68 translate towards the front 22 of the packaging apparatus 10. As the roller tracks 62,68 move towards the front 22 of the packaging apparatus 10, the first plurality of rollers 50 remain in a fixed position with respect to the frame 12. The roller tracks 62,68 continue to move towards the front 22 of the packaging apparatus 10 until the second roller 54 contacts the second stop 66 placing the first packaging device 14 in the first position, as shown in FIG. 2a.

Although the present invention is directed towards the rear servicing of the packaging devices it is envisaged that access, such as a door, may be provided at the front as well, so that limited servicing, such as the changing of a printer ribbon or clearing a bag jam, may be effected.

Where in the foregoing description, reference has been made to specific components or integers of the invention having known equivalents then such equivalents are herein incorporated as if individually set forth.

Although this invention has been described by way of example and with reference to possible embodiments thereof, it is to be understood that modifications or improvements may be made thereto without departing from the scope or spirit of the invention.

It should be noted that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be included within the present invention as defined in the appended claims.

1. An apparatus for producing bags of variable lengths from rolls of plastic film including:
a frame having a front and a rear;
a first sliding roller mechanism mounted to said frame; and
a first bag making device mounted to said first sliding roller mechanism such that said first bag making device can be positioned on said first sliding roller mechanism in a first position wherein said first bag making device can produce bags at the front of said frame and a second position wherein said first bag making device can be accessed for service at said rear of said frame.

2. The apparatus of claim 1 wherein said first bag making device is removeably mounted to said first sliding roller mechanism such that said first bag making device may be unmounted from said first sliding roller mechanism and removed from said frame.

3. The apparatus of claim 1 wherein when said first bag making device is in said first position said first bag making device is located between said front of said frame and said rear of said frame, and when said first bag making device is in said second position said first bag making device is located behind said rear of said frame.

4. The apparatus of claim 1 further including:
a second sliding roller mechanism mounted to said frame; and a second bag making
device mounted to said second sliding roller mechanism such that said second bag making device can be positioned on said second sliding roller mechanism in a first position wherein said second bag making device can produce bags at the front of said frame and a second position wherein said second bag making device can be accessed for service at said rear of said frame.

5. The apparatus of claim 4 wherein either said first bag making device or said second bag making device may be serviced at said rear of said frame, or removed from said frame, without interrupting the bagging operation of the other bag making device that produces bags at said front of said frame.

6. The apparatus of claim 4 wherein said second bag making device is removeably mounted to said second sliding roller mechanism such that said second bag making device may be unmounted from said second sliding roller mechanism and removed from said frame.

7. The apparatus of claim 4 wherein when said second bag making device is in said first position said second bag making device is located between said front of said frame and said rear of said frame, and when said second bag making device is in said second position said second bag making device is located behind said rear of said frame.

8. An apparatus for producing bags of variable lengths from rolls of plastic film including:
a frame having a front, a rear and a side;
a first sliding roller mechanism mounted to said frame; and
a first bag making device mounted to said first sliding roller mechanism such that said first bag making device can be positioned on said first sliding roller mechanism in a first position wherein said first bag making device can produce bags at the front of said frame and a second position wherein said first bag making device can be accessed for service at said side of said frame.

9. The apparatus of claim 8 wherein said first bag making device is removeably mounted to said first sliding roller mechanism such that said first bag making device may be unmounted from said first sliding roller mechanism and removed from said frame.

10. The apparatus of claim 8 wherein when said first bag making device is in said first position said first bag making device is located between said front of said frame and said rear of said frame, and when said first bag making device is in said second position said first bag making device is located at said side of said frame.

11. The apparatus of claim 8 further including:
a second sliding roller mechanism mounted to said frame; and
a second bag making device mounted to said second sliding roller mechanism such that said second bag making device can be positioned on said second sliding roller mechanism in a first position wherein said second bag making device can produce bags at the front of said frame and a second position wherein said second bag making device can be accessed for service at said rear of said frame.

12. The apparatus of claim 11 wherein either said first bag making device or said second bag making device may be serviced at said side of said frame, or removed from said frame, without interrupting the bagging operation of the other bag making device that produces bags at said front of said frame.

13. The apparatus of claim 11 wherein said second bag making device is removeably mounted to said second sliding roller mechanism such that said second bag making device may be unmounted from said second sliding roller mechanism and removed from said frame.

14. The apparatus of claim 11 wherein when said second bag making device is in said first position said second bag making device is located between said front of said frame and said rear of said frame, and when said second bag making device is in said second position said second bag making device is located at said side of said frame.

15. A method of producing bags from a workstation having a frame and at least two bag making devices, including the steps of:
providing at least two bag making devices mounted to the frame of the workstation, said bag making devices being capable of being positioned in a first position or a second position relative to said workstation frame;
operating a first one of said bag making devices to produce bags when said first device is located in said first position; and,
concurrently accessing or removing a second one of said bag making devices from said workstation when said second bag making device is located in said second position such that said second bag making device does not obstruct operation of said first bag making device.

16. An apparatus for producing bags of variable lengths from rolls of plastic film substantially as herein described with reference to the accompanying drawings.

17. A method of producing bags from a workstation substantially as herein described with reference to the accompanying drawings.
